(19) United States
(12) Patent Application Publication
(10) Pub. No.: US 2001/0039833 A1
(43) Pub. Date: Nov. 15, 2001

(54) Respiratory flow sensor

(76) Inventors: Dieter Engel, Reinfeld (DE); Rainer Kunz, Lubeck (DE); Rainer Maria Landich, Herrnburg (DE); Thomas Leyer, Lubeck (DE)

Correspondence Address: MCGLEW & TUTTLE, PC, SCARBOROUGH STATION, SCARBOROUGH, NY, 10510, US

(21) Appl. No.: 09/793,846

(22) Filed: Feb. 26, 2001

(30) Foreign Application Priority Data
May 13, 2000 (DE) DE 100 23 655.3

(51) Int. Cl. G01F 1/68

(52) U.S. Cl. 73/204.27

(57) ABSTRACT

A respiratory flow sensor is provided with two identical or substantially identical first and second wires arranged at spaced locations from one another in a housing through which the respiratory flow flows. The first and second wires can be heated by a respective associated power source. An air resistance body is arranged in the vicinity of the second wire. A third wire is arranged in the housing at a spaced location from the first and second wires and is used to determine the temperature of the respiratory flow via an associated measuring device for the temperature-dependent electric resistor. A central control and evaluating unit is connected to the power sources and to the measuring device and compensates a temperature change of the respiratory flow. The change is detected with the third wire by a change in the heating current flowing through the first and second wires, so that these wires have an operating temperature that is above the temperature of the respiratory flow by a defined amount. A central control and evaluating unit determines the intensity and the direction of the respiratory flow flowing through the housing from the measured heating currents flowing through the first and second wires.

### FIELD OF THE INVENTION

The present invention pertains to a respiratory flow sensor with a first temperature sensor, which is in the area of an air resistance body that is affected by the flow, as well as a second one.

### BACKGROUND OF THE INVENTION

Such a respiratory flow sensor has been known from DE 34 37 595 Cl. The measurement described there is based on the fact that a measuring head installed in the breathing air line of a patient has a first temperature sensor, which is in the area of an air resistance body that is affected by the flow, as well as a second one, which is located outside the area affected by the flow. As in the present invention as well, both temperature sensors are maintained at a defined working temperature that is increased compared with the respiratory gas temperature by means of separate electronic temperature control circuits. The cooling of one temperature sensor, which is brought about for compensation during the breathing or assisted respiration of a patient is determined as a value for the respiratory gas volume flow by means of a measuring instrument and a suitable evaluating unit. By forming the difference of the energy supply values of the two temperature sensors, the direction of flow of the respiratory gas can be determined because the first temperature sensor is cooled more intensely with respect to one direction of flow of the respiratory gas than for the reverse direction, while the second temperature sensor is practically unaffected by the direction of flow of the respiratory gas.

Such respiratory flow sensors are inserted into the breathing air line from the respirator or anesthesia apparatus to the patient and are used for the bidirectional measurement of the gas flow (for the inspiration and the expiration). Depending on the particular application, i.e., e.g., for the respiration of premature infants or adults, the site of installation in the breathing air line as well as the cross section of the respiration line elements connected directly to the respiratory flow sensor, it is necessary to use a respiratory flow sensor under different conditions.

One essential advantage of these prior-art respiratory flow sensors as well as of the respiratory flow sensors according to the present invention is the broad range of measurement, which makes it possible to measure gas volume flow ratios ranging from 1:100 to 1:1,000 with one sensor, i.e., e.g., gas volume flows from 0.5 L per minute to 150 L per minute.

One essential drawback of the prior-art direction-recognizing respiratory flow sensors based on hot wires is that the temperature of the respiratory flow is not yet taken into account during the respiratory flow measurement, so that the measured or determined gas volume flow or gas mass flow is subject to errors. Especially in the case of measuring the respiratory flow to or from the patient near the patient, relatively great errors of measurement may occur because the temperature of the respiratory flow exhaled by the patient is usually higher than that of the inhaled flow and it must therefore be taken into account during the evaluation of the measurement.

Another drawback arises from the fact that a relatively high operating temperature of the hot wires of, e.g., 700° C., which decomposes the anesthetics in the case of use in anesthesia apparatuses and undesired or possibly toxic decomposition products may be formed, is still necessary.

### SUMMARY AND OBJECTS OF THE INVENTION

The object of the present invention is to provide a respiratory flow sensor with hot wires which is improved with respect to the accuracy of measurement and is suitable for use near the patient even in anesthesia apparatuses at low operating temperatures.

According to the invention, a respiratory flow sensor is provided with two identical (substantially identical) first and second wires arranged at spaced locations from one another in a housing through which the respiratory flow flows. The first and second wires can be heated by a respective associated power source. An air resistance body is arranged in the vicinity of the second wire. A third wire is arranged in the housing at a spaced location from the first and second wires and is used to determine the temperature of the respiratory flow via an associated measuring device for the temperature-dependent electric resistor. A central control and evaluating unit is connected to the power sources and to the measuring device and compensates a temperature change of the respiratory flow. The change is detected with the third wire by a change in the heating current flowing through the first and second wires, so that these wires have an operating temperature that is above the temperature of the respiratory flow by a defined amount. A central control and evaluating unit determines the intensity and the direction of the respiratory flow flowing through the housing from the measured heating currents flowing through the first and second wires.

The control and evaluating unit may be connected to a gas analyzer for the determination of the gas species composition and the concentration of the measured respiratory flow, so that the intensity of the respiratory flow is determined by the evaluating unit in a gas-specific manner. The control and evaluating unit may be connected on the output side to a control unit of a respirator or anesthesia apparatus. The first and second wires are arranged essentially in parallel to one another.

The third wire may be arranged essentially in parallel to the direction of the respiratory flow in the housing. The air resistance body may be arranged between the first and second wires. The second wire and the air resistance body may be provided to form a plane at a spaced location from the first wire. The wires may be held via pins. The third wire may have a temperature-dependent electric resistor element. The first and second wires may have an operating temperature that is above the temperature of the respiratory flow by a constant amount of 140° C. to 180° C.

One essential advantage of the present invention arises from the compact design without moving components, so that use near the patient at the tube leading to the patient or at the breathing mask of a patient is possible. The site of installation near the patient is particularly desirable because leakage or buffer volumes that may be present in the respirator or in the anesthesia apparatus thus cannot play a role and cannot distort the measurement.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a schematic top view of a respiratory flow sensor according to the present invention with the most important components; and

FIG. 2 is a longitudinal sectional view through the respiratory flow sensor at right angles to the top view according to FIG. 1.

### DESCRIPTION OF THE PREFERRED EMBODIMENT

Referring to the drawings in particular, a housing 1 made of metal or a plastic is provided defining a space through which the respiratory flow flows to and from the patient (arrows 8 and 9). Two identical first and second wires 4, 5 of a length of about 4 mm each and a diameter of 15 μm are arranged spaced at about 4 mm from one another. The first and second wires 4, 5, which consist of platinum or a platinum alloy, can be heated by means of a respective associated power source 26, 27. An air resistance body 6 is arranged between the first and second wires 4, 5 and in the vicinity of the second wire 5, so that the distance between the two wires 4, 5 is substantially greater than the distance between the air resistance body 6 and the second wire 5. The distance between the air resistance body 6 and the second wire 5 is about 0.5 mm in the exemplary embodiment. A third wire 7 is arranged at a spaced location from the first and second wires 4, 5 in the longitudinal direction of the housing 1 and is used for temperature determination and compensation of the respiratory flow by means of an associated measuring device 25 for the temperature-dependent electric resistance. A central control and evaluating unit 28 is connected to the power sources 26, 27, the measuring device 25 and a gas analyzer 30 for the determination of the gas species composition and the concentration of the gas components of the respiratory flow being measured. The central control and evaluating unit 28 compensates a change in the temperature of the respiratory flow, which change is detected by means of the third wire 7, by changing the heating current flowing through the first and second wires 4, 5, so that these two wires 4, 5 have a defined, constant operating temperature which is above the particular temperature of the respiratory flow. The central control and evaluating unit 28 contains characteristic value pairs of the gas volume flow and the corresponding measured electric voltage of the first wire 4, which were determined before and are stored there. During the use for measurement, the determined measured voltage necessary to supply the electric heating output of the first wire 4 is determined continuously and is displayed and/or forms the output as associated gas volume flow value pairs by the control and evaluating unit 28 on the basis of the value pairs being stored.

In practice, the temperature in the respiratory flow varies from, e.g., 20° C. for inspiratory gas and, e.g., 35° C. for exhaled gas, i.e., the temperature difference is about 15° C. An operating temperature that is about 700° C. above the respiratory gas temperature is generated in the wires 4, 5 in the prior-art respiratory flow sensors, so that the temperature variations of the respiratory gas lead to a relative error in measurement that is less than 5% and is thus acceptable. The respiratory flow sensor according to the present invention is operated with an operating temperature of only about 150° C., so that, on the one hand, the anesthetic gases are not decomposed and, on the other hand, the service life of the heated wires and thus the service life of the respiratory flow sensor are prolonged. However, the desired low operating temperature causes the relative error of measurement of the gas volume flow determined to become unacceptably high because of the variations in the temperature of the respiratory gas. Variations in the temperature of the respiratory gases must therefore be taken into account during the measurement of the respiratory flow. The third wire 7 has for this purpose a temperature-dependent electric resistance, e.g., in the form of a resistor element. The electronic measuring device 25 measures the electric resistance and generates a signal proportional to the change in temperature. The central control and evaluating unit 28 controls the temperature of the wires 4, 5 based on this signal via the power sources 26, 27 such that the temperature difference between the particular current temperature of the respiratory gas and the hot wire temperature is always constant, i.e., no temperature compensation is performed.

The measured signals of the wires 4, 5 strongly depend on the thermal conductivity of the gas mixture, which depends on the composition of the respiratory gas. To compensate this effect, the current gas species composition and the concentration of the gas components are measured. A respiratory flow sample is taken for this purpose continuously by means of a pump, e.g., by means of a Luer connection 29 on the respiratory flow sensor and is determined in a gas analyzer 30. Such a gas analyzer 30 is based, in particular, on the principle of an infrared optical light absorption measurement and makes it possible to determine the gas components and their concentration in a respiratory gas mixture.

Correction values for the measured respiratory flow, i.e., the gas volume flow, are stored in the central control and evaluating unit 28 as a function of the measured gas species composition and the concentration of the gas components, so that the measured respiratory flow is displayed or output in a correspondingly corrected form, e.g., on the control unit 31 of an anesthesia apparatus. As soon as the measured respiratory flow of the patient exceeds a preset threshold value of, e.g., 2 L per minute in the inspiratory direction, which is stored in the control and evaluating unit 28, the control and evaluating unit 28 sends a trigger signal to the control unit 31 of the anesthesia apparatus. The anesthesia apparatus responds to this signal with an increase in pressure corresponding to a programmed, time-dependent respiration pattern of the respiratory gas being delivered to support the respiration effort of the patient.

In the exemplary embodiment, the air resistance body 6 has a diameter of 0.8 mm and is arranged as a semicylinder of an essentially parallel orientation in relation to the wires 4, 5 and with an essentially right-angled orientation to the third wire 7 and to the direction of the respiratory gas through the housing 1. The wires 4, 5, 7 are held in pairs by means of the pins 13, 15; 14, 17 and 16, 18.

To determine the direction of flow of the respiratory flow, the measured voltages of the two wires 4, 5 are determined continuously and the quotient of these measured values is formed. Stored reference values for the quotient, which determine the current direction of flow as a function of the composition and the concentration of the respiratory gas, are present in the central control and evaluating unit 28. The result is displayed and/or forms the output by the control and evaluating unit 28.

The respiratory flow sensor is used in the exemplary embodiment such that the gas volume flow is determined, but the device according to the present invention is also suitable, in principle, for displaying or outputting mass flows based on a corresponding configuration of the conversion values stored in the central control and evaluating unit 28.

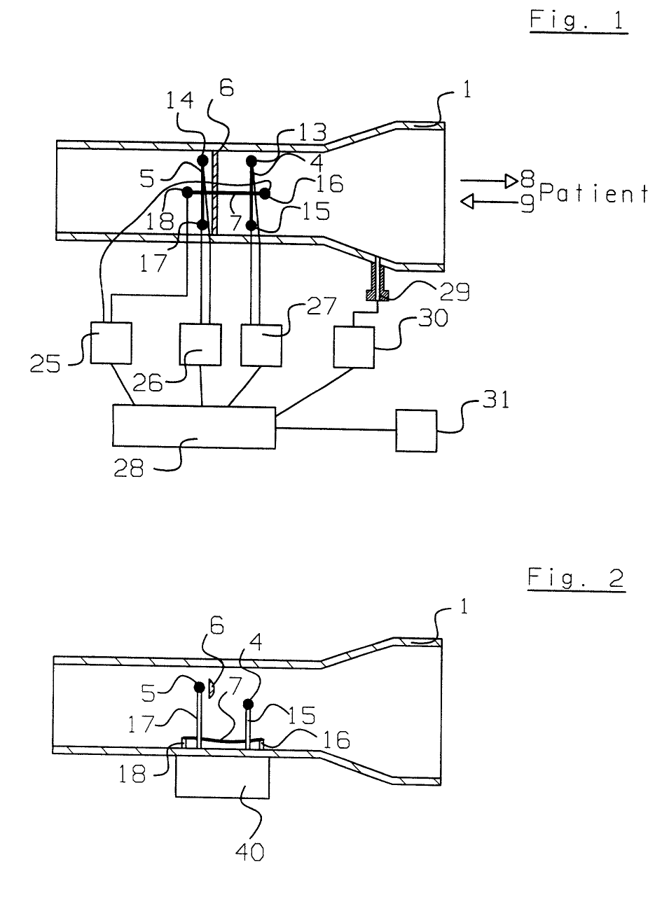

In the view according to FIG. 2, a plug-type connection 40 of rectangular contour is located centrally at the bottom of the housing 1 for the electrical connection to the components according to FIG. 1, which are arranged outside the housing 1. FIG. 2 also shows that the first and second wires 4, 5 are offset in height in relation to one another, but also and especially in relation to the third wire 7, so that mutual signal interferences are ruled out to the extent possible and the air resistance body 6 can act on the second wire 5 only.

While a specific embodiment of the invention has been shown and described in detail to illustrate the application of the principles of the invention, it will be understood that the invention may be embodied otherwise without departing from such principles.

What is claimed is:

1. A respiratory flow sensor comprising:
a housing defining a flow space through which the respiratory flow flows;
substantially identical first wire and second wire arranged at spaced locations from one another in said housing flow space;
a power source for heating said first and second wires;
an air resistance body arranged in a vicinity of said second wire;
a measuring device;
a third wire connected to said measuring device as a temperature-dependent electric resistor and arranged in said housing at a spaced location from said first wire and from said second wire, said third wire for determining the temperature of the respiratory flow with said measuring device;
a central control and evaluating unit connected to the said power source and connected to said measuring device, said central control unit compensating a temperature change of the respiratory flow detected by said third wire based on a change in the heating current flowing through the said first and second wires to provide said first and second wires with an operating temperature that is above the temperature of the respiratory flow by a defined amount and said central control and evaluating unit determining an intensity and the direction of the respiratory flow flowing through said housing from the measured heating currents flowing through said first and second wires.

2. A respiratory flow sensor in accordance with claim 1, further comprising: a gas analyzer, wherein said control and evaluating unit is connected to said gas analyzer for the determination of the gas species composition and the concentration of the measured respiratory flow, and the intensity of the respiratory flow is determined by said evaluating unit in a gas-specific manner.

3. A respiratory flow sensor in accordance with claim 1, wherein said control and evaluating unit is connected on an output side to a control unit of a respirator or anesthesia apparatus.

4. A respiratory flow sensor in accordance with claim 1, wherein said first and second wires are arranged essentially in parallel to one another.

5. A respiratory flow sensor in accordance with claim 1, wherein said third wire is arranged essentially in parallel to a direction of the respiratory flow in said housing.

6. A respiratory flow sensor in accordance with claim 1, wherein said air resistance body is arranged between said first and second wires.

7. A respiratory flow sensor in accordance with claim 1, wherein said second wire and said air resistance body form a plane at a spaced location from said first wire.

8. A respiratory flow sensor in accordance with claim 1, wherein said wires are held by pins.

9. A respiratory flow sensor in accordance with claim 1, wherein said third wire has a temperature-dependent electric resistor element.

10. A respiratory flow sensor in accordance with claim 1, wherein said first and second wires have an operating temperature that is above the temperature of the respiratory flow by a constant amount of 140° C., to 180° C.
